(19) United States
(12) Patent Application Publication
(10) Pub. No.: US 2026/0006592 A1
(43) Pub. Date: Jan. 1, 2026

(54) RELAY OPERATION IN WIRELESS NETWORKS

(71) Applicant: Samsung Electronics Co., Ltd., Suwon-si (KR)

(72) Inventors: Peshal Nayak, Plano, TX (US); Bilal Sadiq, Plano, TX (US); Vishnu Vardhan Ratnam, Frisco, TX (US); Rubayet Shafin, Allen, TX (US); Yue Qi, Plano, TX (US); Boon Loong Ng, Plano, TX (US)

(21) Appl. No.: 19/231,318

(22) Filed: Jun. 6, 2025

Related U.S. Application Data
(60) Provisional application No. 63/665,163, filed on Jun. 27, 2024.
(60) Provisional application No. 63/665,166, filed on Jun. 27, 2024.
(60) Provisional application No. 63/665,170, filed on Jun. 27, 2024.
(60) Provisional application No. 63/786,715, filed on Apr. 10, 2025.
(60) Provisional application No. 63/786,692, filed on Apr. 10, 2025.

(51) Int. Cl. H04W 72/0446; H04W 76/14; H04W 84/12; H04W 88/04

(52) U.S. Cl. CPC H04W 72/0446; H04W 76/14; H04W 84/12; H04W 88/04

(57) ABSTRACT

In an embodiment, a station (STA) may communicate with an access point (AP) via one or more relay stations, where a relay station may perform relay operations between the STA and the AP, including forwarding data packets both on the uplink and the downlink between the AP and the STA. An optimal relay STA may be selected from available relay STAs based on various channel measurements and statistics regarding a channel quality between the relay STA and the STA or AP.

### CROSS-REFERENCE TO RELATED APPLICATIONS

This application claims the benefit of priority from U.S. Provisional Application No. 63/665,163 entitled “AP TRIGGERED SEARCH AND RELAY SELECTION PROCEDURE FOR NEXT GENERATION WLANS” filed Jun. 27, 2024; U.S. Provisional Application No. 63/665,166, entitled “STA-SIDE DISCOVERY OF RELAY FOR NEXT GENERATION WLANS” filed Jun. 27, 2024; U.S. Provisional Application No. 63/665,170, entitled “COMMUNICATION WITH AP THROUGH A CLIENT-SELECTED RELAY” filed Jun. 27, 2024; U.S. Provisional Application No. 63/786,715, entitled “STA-SIDE DISCOVERY OF RELAY FOR NEXT GENERATION WLANS” filed Apr. 10, 2025; and U.S. Provisional Application No. 63/786,692, entitled “COMMUNICATION WITH AP THROUGH A CLIENT-SELECTED RELAY” filed Apr. 10, 2025, all of which are incorporated herein by reference in their entireties.

### TECHNICAL FIELD

This disclosure relates generally to a wireless communication system, and more particularly to, for example, but not limited to, relay operations in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides a station (STA) in a wireless network, the STA comprising: a memory; and a processor coupled to the memory. The processor is configured to transmit, to an access point (AP) associated with the STA, a first frame including an identifier of a relay STA and requesting that the AP communicate with the STA via the relay STA. The processor is configured to receive, from the AP, a second frame that confirms the request in the first frame. The processor is configured to communicate one or more frames with the AP via the relay STA in response to the second frame.

In some embodiments, the first frame includes timing information indicating when STA is to initiate communication with the AP via the relay STA; and the processor is further configured to initiate the communication with the AP via the relay STA based on the timing information.

In some embodiments, the STA remains associated with the AP while communicating with the AP via the relay STA.

In some embodiments, the processor is further configured to: transmit, to the AP, a third frame that indicates a teardown of the communication with the AP via the relay STA; and initiate communication directly with the AP after transmitting the third frame.

In some embodiments, the processor is configured to: transmit, to one or more other STAs, a third frame indicating that the one or more other STAs are candidates for the relay STA; receive, from each of the one or more other STAs, a respective frame including signal strength information indicative of communication quality between the STA and a respective other STA; and select the relay STA among the one or more other STAs based on the signal strength information.

In some embodiments, the processor is configured to: transmit, to the AP, a third frame indicating one or more other STAs that are candidates for the relay STA; receive, from the AP, a fourth frame that includes signal strength information indicative of communication quality between the AP and a respective STA in the one or more other STAs; and select the relay STA among the one or more other STAs based on the signal strength information.

In some embodiments, the processor is configured to: receive, from the AP, a third frame that requests signal strength information of a signal between the AP and the STA; and transmit, to the AP, a fourth frame that includes the signal strength information of the signal between the AP and the STA.

One aspect of the present disclosure provides an access point (AP) in a wireless network, the AP comprising: a memory; and a processor coupled to the memory. The processor is configured to receive, from a station (STA) associated with the AP, a first frame including an identifier of a relay STA and requesting that the AP communicate with the STA via the relay STA. The processor is configured to transmit, to the STA, a second frame that confirms the request in the first frame. The processor is configured to communicate one or more frames with the STA via the relay STA in response to the second frame.

In some embodiments, the processor is further configured to: transmit, to the relay STA, a third frame requesting confirmation that the relay STA will perform relay operations for the STA; and receive, from the relay STA, a fourth frame in response to the third frame that confirms that the relay STA will perform the relay operations for the STA.

In some embodiments, the first frame includes timing information indicating when the STA is to initiate communication with the AP via the relay STA; and the processor is configured to initiate the communication with the STA via the relay STA based on the timing information.

In some embodiments, the AP remains associated with the STA while communicating with the STA via the relay STA.

In some embodiments, the processor is further configured to: receive, from the STA, a third frame that indicates a teardown of the communication with the AP via the relay STA; and initiate communication directly with the STA after receiving the third frame.

In some embodiments, the processor is further configured to receive, from the STA, a third frame indicating one or more other STAs that are candidates for the relay STA; and transmit, to the STA, a fourth frame that includes signal strength information indicative of communication quality between the AP and a respective STA in the one or more other STAs.

In some embodiments, the processor is further configured to transmit, to the STA, a third frame that requests signal strength information of a signal between the AP and the STA; and receive, from the STA, a fourth frame that includes the signal strength information of the signal between the AP and the STA.

One aspect of the present disclosure provides a relay station (STA) in a wireless network, the relay STA comprising: a memory; and a processor coupled to the memory. The processor is configured to receive, from an access point (AP), a first frame requesting confirmation that the relay STA will perform relay operations for a STA. The processor is configured to transmit, to the AP, a second frame in response to the first frame that confirms that the relay STA will perform the relay operations for the STA. The processor is configured to receive, from the AP, a third frame intended for STA and forward the third frame to the STA. The processor is configured to receive, from the STA, a fourth frame intended for the AP and forward the fourth frame to the AP.

In some embodiments, the processor is further configured to: receive, from the STA, a fifth frame that includes an identifier of the relay STA that the STA is considering for performing relay operations for the STA; and transmit, to the STA, a sixth frame that includes signal strength information indicative of communication quality between the relay STA and the STA.

In some embodiments, the processor is further configured to: receive, from the AP, a fifth frame that includes an identifier of the relay STA that the AP is considering for performing relay operations for the STA; and transmit, to the AP, a sixth frame that includes signal strength information indicative of communication quality between the relay STA and the AP.

In some embodiments, the fifth frame is a null data packet announcement frame and the sixth frame is a compressed beamforming report.

In some embodiments, the processor is further configured to transmit, to the AP on behalf of the STA, a fifth frame that requests that the AP communicate with the STA via the relay STA.

In some embodiments, the processor is further configured to transmit, to the AP on behalf of the STA, a fifth frame that indicates a teardown of the communication via the relay STA.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates an example of using a relay STA in accordance with an embodiment.

FIG. 5 illustrates an example of a relay operation setup in accordance with an embodiment.

FIG. 6 illustrates an example timeline of a relay operation in accordance with an embodiment.

FIG. 7 illustrates an example timeline of switching a relay STA in accordance with an embodiment.

FIG. 8 illustrates a data path for relay operation realized at a media access control (MAC) layer in accordance with an embodiment.

FIG. 9 illustrates an example of a relay element in accordance with an embodiment.

FIG. 10 illustrates an example setup and teardown of a relay based communication in accordance with an embodiment.

FIG. 11 illustrates an example of a STA determining a relay STA in accordance with an embodiment.

FIG. 12 illustrates an example of a STA determining a relay STA in accordance with an embodiment.

FIG. 13 illustrates an example of an AP determining a relay STA in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter.

As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

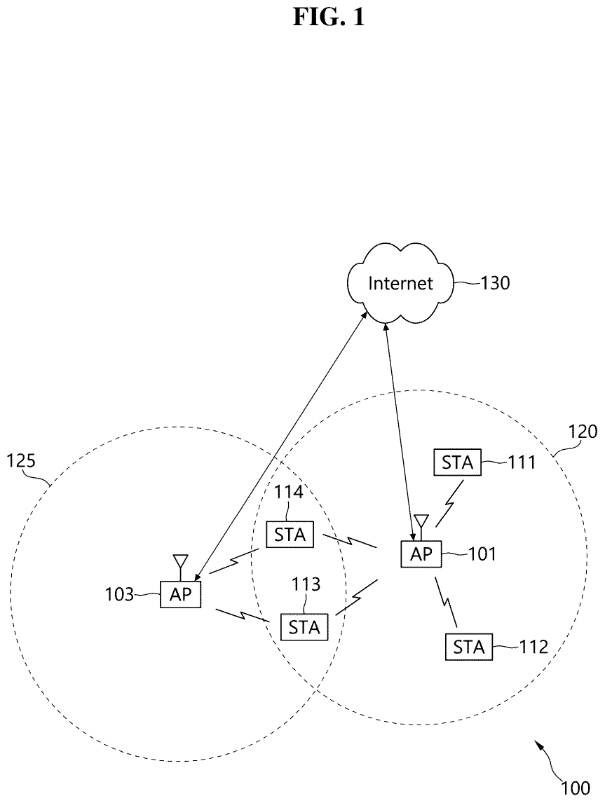

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

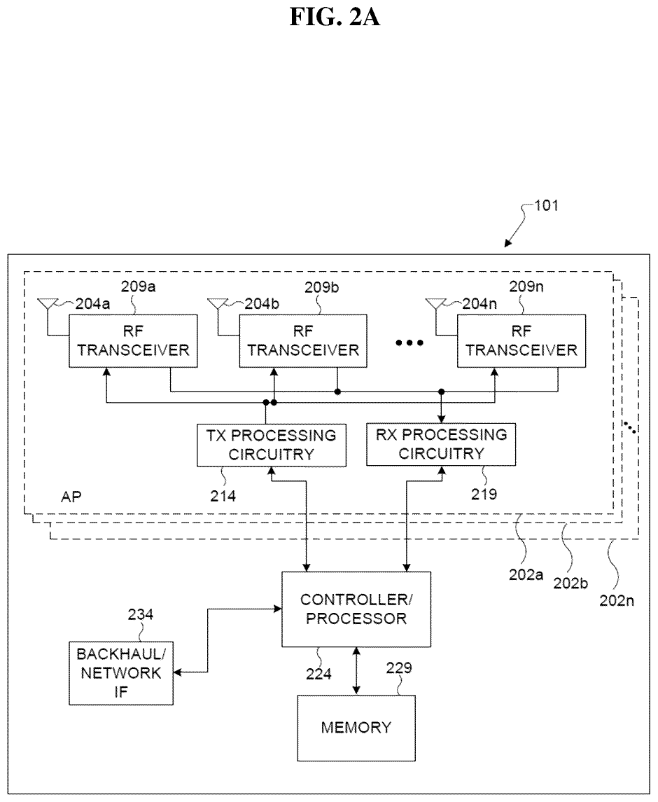

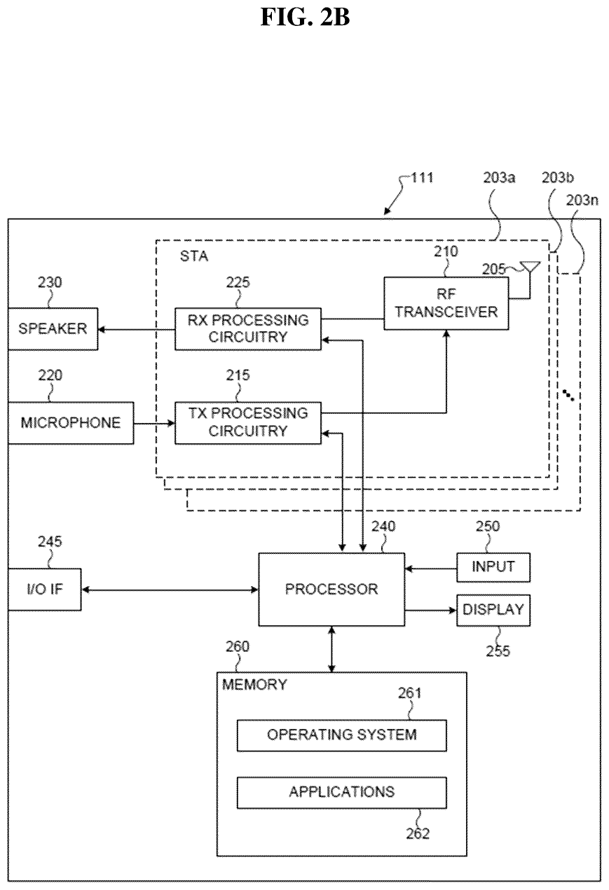

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiments, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of an STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiments, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

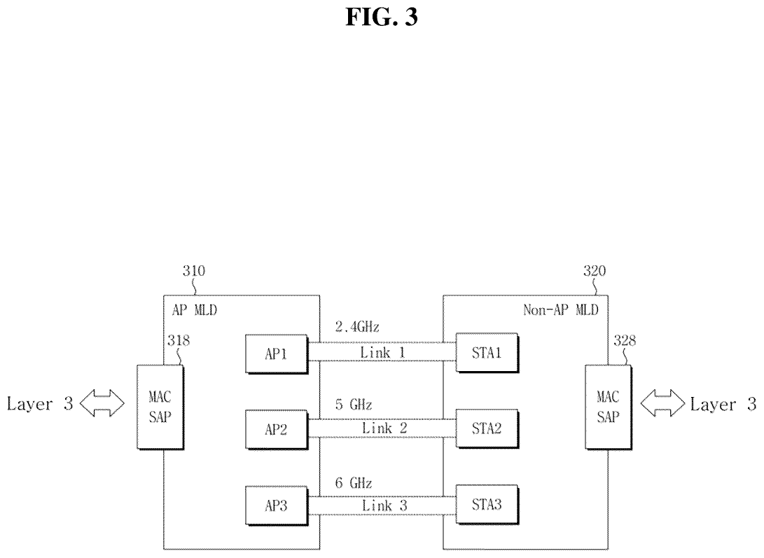

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11be/D5.0, “Wireless LAN Medium Access Control (MAC) and Physical Layer (PHY) Specifications.

An objective of wireless networks is to increase the range of wireless connectivity of an AP so that users can get connectivity in areas where an AP's signal may be weak or not available. Accordingly, a relay STA can be used for supporting this functionality. In particular, a relay may act as an intermediate node that can forward packets received from the AP to the non-AP STA.

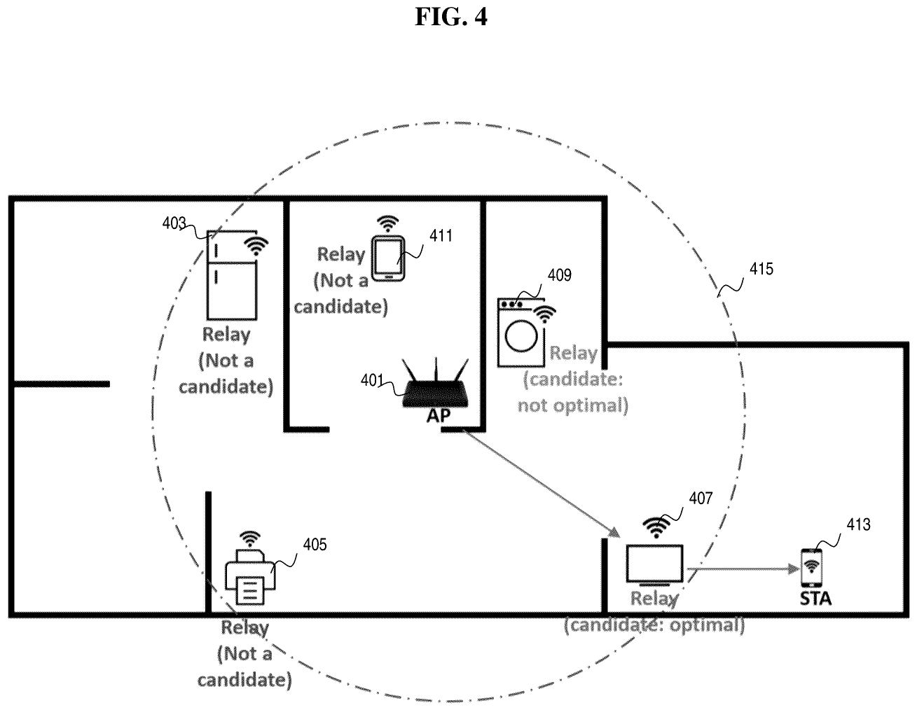

FIG. 4 illustrates an example of using a relay STA in accordance with an embodiment. In particular, FIG. 4 Ilustre's an example of a smart home where there may be several STA devices with wireless communication capabilities. In particular, the smart home includes an AP 401 that communicates with STA 403 (e.g., wireless refrigerator), STA 405 (e.g., wireless printer), STA 407 (e.g., wireless TV), STA 409 (e.g., wireless washing machine), and STA 411 (e.g., wireless computer). Further, the AP may be communicating with STA 413 (e.g., wireless phone). In some embodiments, one or more of these STAs may act as a relay STA to enhance a range of the AP 401. As illustrated, the AP's range may be estimated by the dotted circle 415. Accordingly, when a user steps outside this circle 415, such as illustrated by STA 413, the STA 413 may receive a poor connection or connection that is unavailable with the AP 401. Accordingly, in some embodiments, one or more neighboring STAs (e.g., STA 403, 405, 407, 409, and/or 411 among others) may act as a relay STA (whereby the relay STA may be referred to as a relay node, intermediate node, among others) that forward the user's traffic to the AP so that even when the user is in weak connection areas (e.g., outside of the AP 401 range 415), the STA can continue to have wireless communication.

In some embodiments, an STA may be within an AP's range but there can be a transmit power asymmetry. For example, due to power constraints, the STA may be transmitted at lower power compared to the AP (e.g., the AP may be wall powered and hence can transmit at higher power while the user's STA may be battery powered). Accordingly, the STA may be able to obtain the AP's transmission. However, on the uplink, the AP may not be able to receive the user's transmission. Accordingly, embodiments in accordance with this disclosure may utilize one or more relay STA to maintain communication between an STA and an AP.

In some embodiments, a relay operation may be a standard and/or may be realized via a proprietary framework. However, the STA may need to inform the AP about the transition to relay operation when the STA decides to switch.

In some embodiments, the STA may need to discover an optimal relay STA candidate located within the STA's vicinity. In some embodiments, an AP may perform a triggered search and select the optimal relay STA from multiple relay STA candidates.

In some embodiments, the STA may select a relay STA for itself. In some embodiments, the STA may use a standardized procedure, a proprietary procedure, a neighbor awareness networking (NAN) based operation, among others.

In some embodiments, the STA may transmit a switch message to the AP to inform the AP about the STA selected relay STA. The switch message may include at least one or more of the information items as indicated in Table 1.

Table 1 provides information items that can be present in a switch message from an STA to an AP in accordance with an embodiment.

TABLE 1

| Information | |
|---|---|
| items | Description |
| Selected relay | One or more information item(s) that can describe the relay STA that |
| identifier | the STA has selected. e.g., relay STA media access control (MAC) |
| | address, relay STA association identifier (AID), among others. |
| Switch time | One or more information item(s) that can describe a time at which a |
| | switch may occur. e.g., a number of target beacon transmission times |
| | (TBTTs) from the current TBTT at which the switch can occur, if the |
| | switch may be performed instantaneously, after a certain number of |
| | time indicated in, for example, microseconds, among others. |

Upon receiving a switch message as indicated in Table 1, the AP can forward data of the STA to the indicated relay STA at the indicated time. The relay STA can then forward the data to the STA.

In some embodiments, when the AP is forwarding the data of the STA to the indicated relay STA, the AP can maintain the association state of the STA. This can enable the STA to return back to the AP without another (Re)association.

In some embodiments, when the STA returns to the AP, the STA can transmit another message to the AP to inform the AP about the STA's return. Upon reception of this message, the AP can stop forwarding the data to the relay STA and start forwarding the data to the STA.

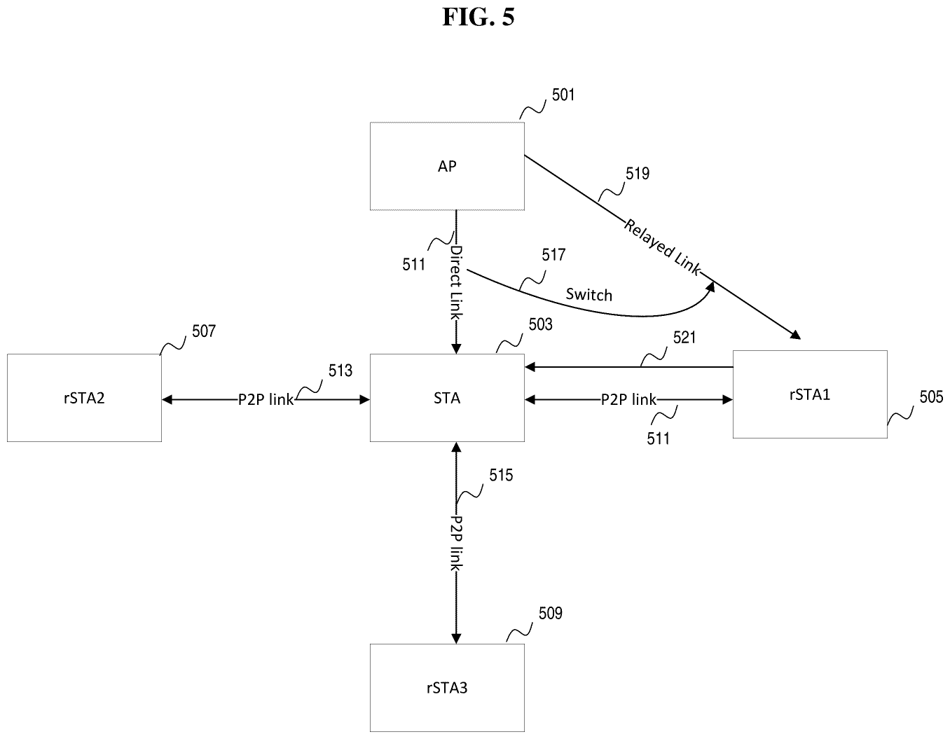

FIG. 5 illustrates an example of a relay operation setup in accordance with an embodiment. In particular, FIG. 5 illustrates an AP 501, a STA 504, a relay STA (rSTA) 505, rSTA2 507, and rSTA3 509. The AP 501 has a direct link 511 setup with the STA 503. The STA has a P2P link 511 setup with the rSTA1 505, a P2P link 513 setup with rSTA2 507, a P2P link 515 setup with rSTA3 509. The STA 501 may communicate with the AP 503 to switch 517 the direct link 511 to a relayed link 519 using the rSTA1 505 as the relay STA. Accordingly, after the switch 517, the AP 501 may communicate with the STA 503 via rSTA1 505 which is the selected relay STA, whereby rSTA1 505 will forward data 521 being communicated between the AP 501 and the STA 503.

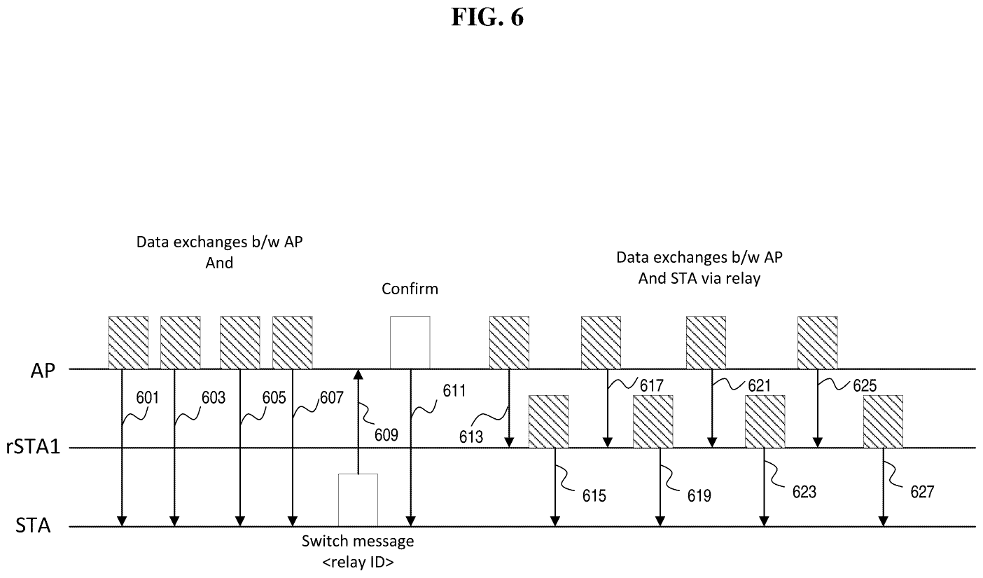

FIG. 6 illustrates an example timeline of a relay operation in accordance with an embodiment. In particular, FIG. 6 illustrates communication among an AP, rSTA1, and STA. In operations 601, 603, 605 and 607, the AP transmits data packets directly to the STA. In operation 609, the STA transmits to the AP a switch message. The switch message may include a relay identifier that identifies a relay STA that is to perform relay operations on behalf of the STA.

Accordingly, in operation 611, the AP transmits to the STA a confirmation message where the confirmation message may indicate that the switch to the relay STA is successful. Accordingly, in operation 613 the AP transmits a data packet to the rSTA1 and in operation 615, the rSTA forwards the data packet to the STA. In operation 617 the AP transmits a data packet to the rSTA1and in operation 619, the rSTA forwards the data packet to the STA. In operation 621 the AP transmits a data packet to the rSTA1 and in operation 623, the rSTA forwards the data packet to the STA. In operation 625 the AP transmits a data packet to the rSTA1 and in operation 627, the rSTA forwards the data packet to the STA.

Accordingly, the rSTA performs relay operations to relay communications between the AP and the STA. In some embodiments, the STA may inform the AP to stop forwarding data to a relay STA and to switch to a different relay STA to forward data to.

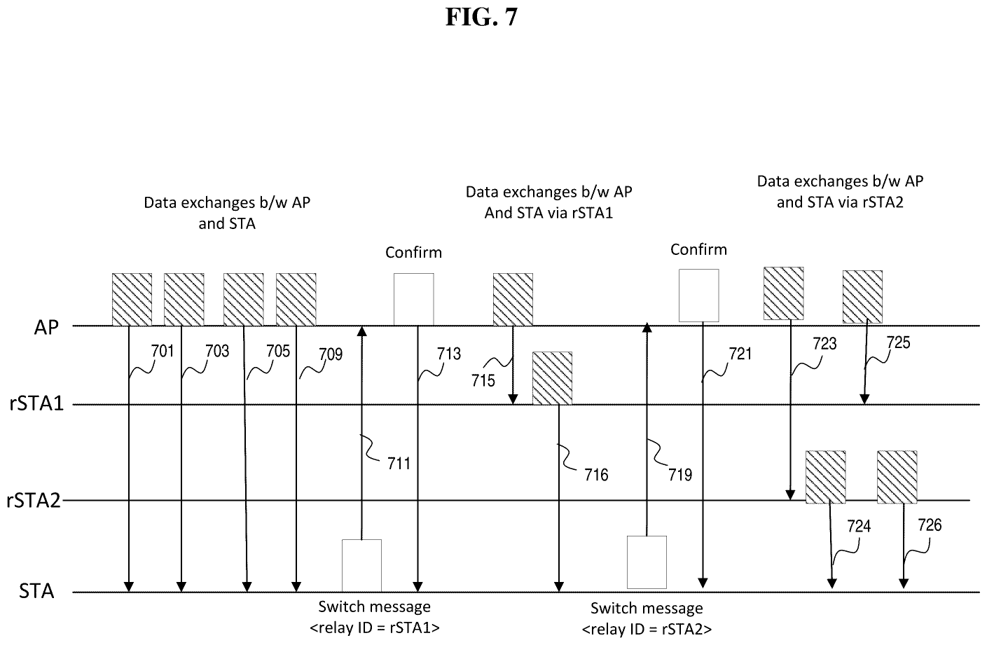

FIG. 7 illustrates an example timeline of switching a relay STA in accordance with an embodiment. In particular, FIG. 7 illustrates communication among an AP, rSTA1, rSTA2, and STA. Initially, the AP communicates directly with the STA. In operations 701, 703, 705 and 709, the AP transmits to STA several data frames. In operation 711, the STA transmits to the AP a switch message (<relay ID=rSTA1>) that identifies rSTA as the relay STA. In operation 713, the AP transmits a confirmation message to the STA. Accordingly, the AP communicates with the STA via rSTA1. In particular, in operation 715, the AP transmits to rSTA1 a data packet and in operation 716 the rSTA1 forwards the data packet to the STA. In operation 719, the STA then transmits another switch message <relay ID=rSTA2>) to the AP that indicates a switch to rSTA2 as the relay STA. Thus, the AP switches to rSTA2 as the relay STA between the AP and the STA. Accordingly, in operation 723, the AP transmits to rSTA2 a data packet and in operation 724 the rSTA2 forwards the data packet to the STA. In operation 725, the AP transmits to rSTA2 a data packet and in operation 726, the rSTA2 forwards the data packet to the STA.

In some embodiments, a relay STA may be used in the uplink direction. In some embodiments, a relay STA may be used for both uplink and downlink communication between an AP and a STA. In some embodiments, a switch message may be transmitted by a relay STA on behalf of a STA.

In some embodiments, a STA may request the relay STA to transmit the switch message on the STA's behalf. The switch message may be sent such that the AP is able to authenticate that the switch message has been requested by the STA. In some embodiments, the AP and STA may establish security or encryption keys through which the AP can verify that the switch message received from a relay STA on behalf of the STA is authentic.

In some embodiments, when the STA informs the AP about a suitable relay STA, the AP may perform a check with the relay STA. In some embodiments, a check may be performed by transmitting a check message. In some embodiments, a check message may include one or more of the information items as shown in Table 2.

Table 2 provides Information items that can be present in the check message in accordance with an embodiment.

TABLE 2

| Information | |
|---|---|
| items | Description |
| Relay identifier | One or more information items that can identify the relay STA. e.g., |
| | relay STA's MAC address. |
| STA identifier | One or more information items that can identify the STA that has |
| | chosen the relay STA. e.g., STA's MAC address, AID, among others. |
| Switch time | One or more information item(s) that can describe a time at which a |
| | switch can occur. e.g., the number of TBTTs from the current TBTT at |
| | which the switch can occur, instantaneously, after a certain number of |
| | time indicate in microseconds, among others. |

In some embodiments, the relay STA may transmit a confirmation message which can confirm that the relay agrees to act as a relay STA for the STA. Upon receiving the confirmation message from the relay STA, the AP can start sending the frames to the relay STA.

In some embodiments, there may be a teardown message which can be used to teardown a relay communication among a relay STA, AP and STA. In some embodiments, a teardown message may include at least one or more of the information items as shown in Table 3.

Table 3 provides information items that can be present in a teardown message in accordance with an embodiment.

TABLE 3

| Information | |
|---|---|
| items | Description |
| Relay STA | One or more information items that can identify the relay STA. e.g., |
| identifier | relay STA MAC address. |
| STA identifier | One or more information items that can identify the STA that has |
| | chosen the relay STA. e.g., STA's MAC address, AID, among others. |
| Teardown time | One or more information item(s) that can describe the time at which the |
| | teardown can occur. e.g., the number of TBTTs from the current TBTT |
| | at which the teardown can occur, instantaneously, after a certain number |
| | of time indicate in microseconds, among others. |

In some embodiments, a teardown may be a notification message after which the teardown can occur.

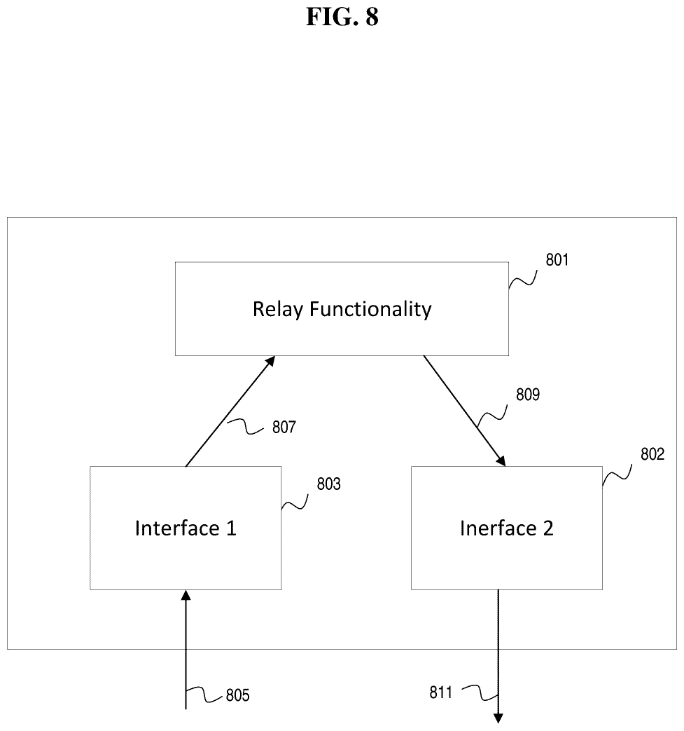

In some embodiments, a relay function can be realized in implementation as shown in FIG. 8. In particular, FIG. 8 illustrates a data path for relay operation realized at a particular layer. In some embodiments, a relay function may be implemented above the upper MAC layer. The upper MAC layer may refer to functions within the Media Access Control (MAC) sublayer of the Data Link Layer in the IEEE 802.11 standards.

As illustrated, the relay function may include an interface 1 803, an interface 2 802, and a relay functionality 801. As illustrated, in operation 805, a packet is received on interface 1 803 (e.g., Wi-Fi interface, Bluetooth interface, among others). In operation 807, the packet is passed from the interface 1 803 to the relay functionality 801 (e.g., implemented as a microkernel, among other implementations). The relay functionality 801 may determine that the end STA of the packet is reachable through interface 2 802. In operation 809, the relay functionality 801 passes the packet to interface 2 802. Accordingly, in operation 811 the interface 2 802 transmits the packet to the end STA. In FIG. 8, the MAC address of the receiver in the packet received can correspond to the MAC of interface 1 803. The internet protocol (IP) address may specify the address of the end STA. When the packet is transmitted by interface 2 802, the receiver address at the MAC layer can be that of the end STA.

In some embodiments, the relay functionality may maintain a record of different interfaces that may be used to send packets to different STAs.

In some embodiments, a management frame may be used to inform an AP about the relay STA selection. In some embodiments, a management frame may include a relay element.

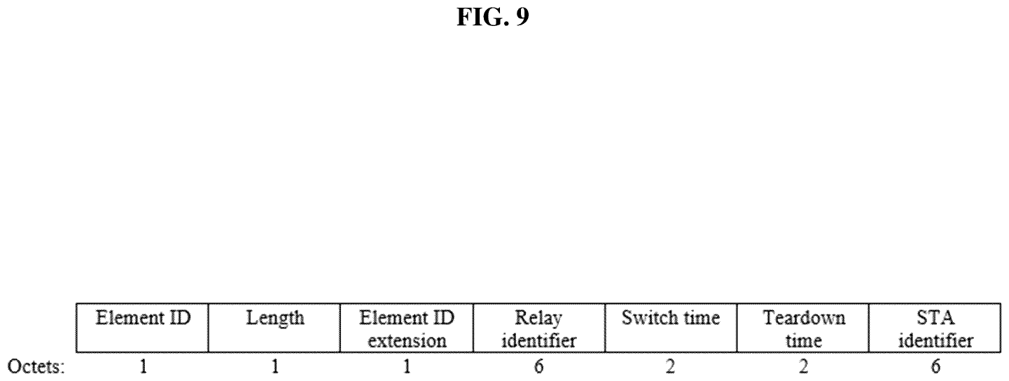

FIG. 9 illustrates an example of a relay element in accordance with an embodiment. The relay element may include an element ID field, a length ID field, an element ID extension field, a relay identifier field, a switch time field, a teardown time field, and a STA identifier field. The element ID field and the element ID extension field may provide identifier information for the element. The length field may provide length information for the element. The relay identifier field may provide a MAC address of a relay STA. The switch time field may provide a time relative to a time synchronization function (TSF) time of the STA at which a switch may occur. The teardown time field may provide information regarding a time at which a teardown may occur.

The STA identifier field may provide a MAC address of the STA that is transmitting the relay element.

In some embodiments, a switch request may be an action frame. Table 4 provides a switch request frame format in accordance with an embodiment.

TABLE 4

| Order | Meaning |
|---|---|
| 1 | Category |
| 2 | Protected ultra-high reliability (UHR) |
| | Action (can be other types as well |
| | such as extremely high throughput (EHT), among others) |
| 3 | Dialog Token |
| 4 | Relay element |

The category field may provide a category of the switch request. The protected ultra-high reliability (UHR) action field may provide information to differentiate different action frame formats. The dialog token field may provide unique identifier information for frame exchanges. The relay element may include relay information as illustrated in FIG. 9 in accordance with an embodiment.

In some embodiments, a confirmation message may be transmitted in response to a switch request message. Table 5 illustrates an example format of a confirm message in accordance with an embodiment.

TABLE 5

| Order | Meaning |
|---|---|
| 1 | Category |
| 2 | Protected UHR Action (can be other types as well such as EHT, |
| | among others) |
| 3 | Dialog Token |
| 4 | Relay element |

The category field may provide a category of confirmation messages. The protected ultra-high reliability (UHR) action field may provide information to differentiate different action frame formats. The dialog token field may provide unique identifier information for frame exchanges. The relay element may include relay information as illustrated in FIG. 9 in accordance with an embodiment.

In some embodiments, a switch message may have the final content that is approved for the STA (e.g., based on finalization between the AP and the relay STA).

In some embodiments, a check message may have the same format as the switch message.

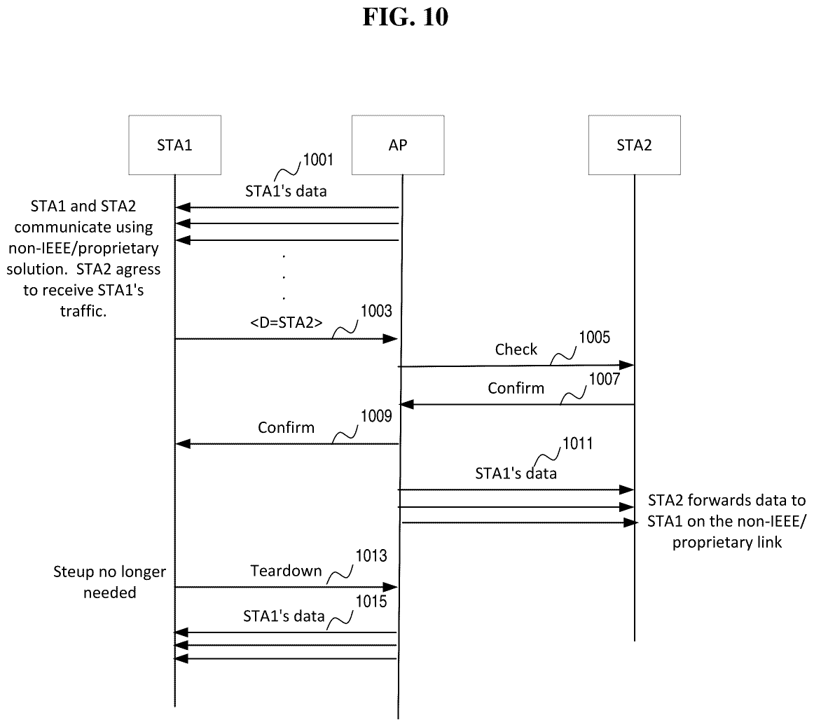

FIG. 10 illustrates an example setup and teardown of relay based communication in accordance with an embodiment. In particular, FIG. 10 illustrates communication among STA1, AP and STA2. Initially, in operation 1001, STA1 receives data from the AP. However, STA1 may be experiencing a low quality link to the AP. Accordingly, STA1 may identify a suitable relay STA, STA2.

Furthermore, STA1 and STA2 may be communicating using a different communication protocol (e.g., non-IEEE or proprietary protocol). STA2 and STA1 may communicate whereby STA2 may agree to receive STA1's traffic from the AP. Accordingly, in operation 1003, STA1 transmits to the AP a switch request message <D=STA2) that identifies STA2 as the relay STA that should be used for future communication with STA1. In operation 1005, the AP transmits a check message to the STA2 to check whether the STA2 is willing to operate as the relay STA for communication to STA1. In operation 1007, STA2 transmits a confirm message that confirms that STA2 is willing to perform as the relay STA for STA1. Accordingly, in operation 1009, the AP transmits a confirm message to STA1 that provides a confirmation that STA2 will operate as the relay STA. Accordingly, in operation 1011, the AP transmits, to STA2, STA1's data, and STA2 forwards the STA1's data to STA1 on the non-IEEE or propriety link. The AP may keep STA1's association status alive and transmit STA1's data to STA2. Then, in operation 1013, STA1 transmits to the AP a teardown message that requests that the relay STA communication be torn down. The setup may be terminated when it is not necessary and STA1 may return to the AP without requiring a reassociation. Accordingly, in operation 1015, the AP directly transmits STA1's data to STA1. In some embodiments, trust may be implicitly established as the AP checks with STA2 before switching traffic.

In some embodiments, the STA can transmit an announcement message to announce the relay candidate that the STA intends to consider. The announcement message may include one or more of the information items as indicated in Table 6.

Table 6 provides information items that can be present in an announcement message in accordance with an embodiment.

TABLE 6

| Information | |
|---|---|
| items | Description |
| Relay | One or more information items that can indicate the identifiers of the relay |
| identifier | STAs that the STA considers as potential relays for the STA. E.g., relay |
| | STA MAC address, AID, among others. |
| AP identifier | One or more information items that can indicate the AP. e.g., basic service |
| | set identifier (BSSID), special AID for the AP, among others. |

Upon receiving an announcement message and one or more measurement message following the announcement message, the relay STA and/or the AP can respond with a response message which may include one or more information items as indicated in Table 7.

Table 7 provides one or more information items that can be present in a response message in accordance with an embodiment.

TABLE 7

| Information | |
|---|---|
| items | Description |
| Signal strength | One or more information items that can include parameters that can |
| measurement | provide the STA with the signal strength measurement between the |
| | STA and the relay or AP. e.g., downlink SNR, received signal strength |
| | indicator (RSSI) among others. The response message may optionally |
| | also carry backhaul (between relay STA and AP) channel quality or |
| | signal strength indication. This quality may be available at the relay |
| | STA. e.g., from recent beacons or data transmissions between relay |
| | STA and AP. |
| Channel state | One or more information items that can include parameters that can |
| information | provide the STA with information related to the channel state |
| | information. |

In some embodiments, when the STA receives a response message, the STA can select an optimal relay STA from one or more available relay STAs in the vicinity of the STA. In some embodiments, in order to determine channel states with different relay STAs, the STA can bypass the AP and the STA may measure a channel state to each of the available relay STAs only.

In some embodiments, the STA may assess whether the STA needs relay assistance (e.g., based on high retransmission rate, lower signal strength among other factors). The STA may check one or more AP announcements regarding available relay STAs. In some embodiments, the STA may also perform relay STA discovery on the STA's own. In some embodiments, the STA may transmit a null data packet announcement (NDPA) message announcing one or more relay STAs. In some embodiments, the STA may transmit an NDPA to the AP. Accordingly, the relay STAs and/or AP may respond with a response message. In some embodiments, the response message may be a compressed beamforming report (CBR) message. In some embodiments, a first device in an NDPA message may transmit a response message without receiving a CBR poll, and the remaining devices may be polled. In some embodiments, a relay response message may include an indication of a backhaul channel quality, such as estimated date rate, signal strength, among various other channel quality metrics. In some embodiments, a relay STA may maintain channel quality statistics that may be used for non-relay related communication with the AP and the relay STA may provide these statistics to the STA as well.

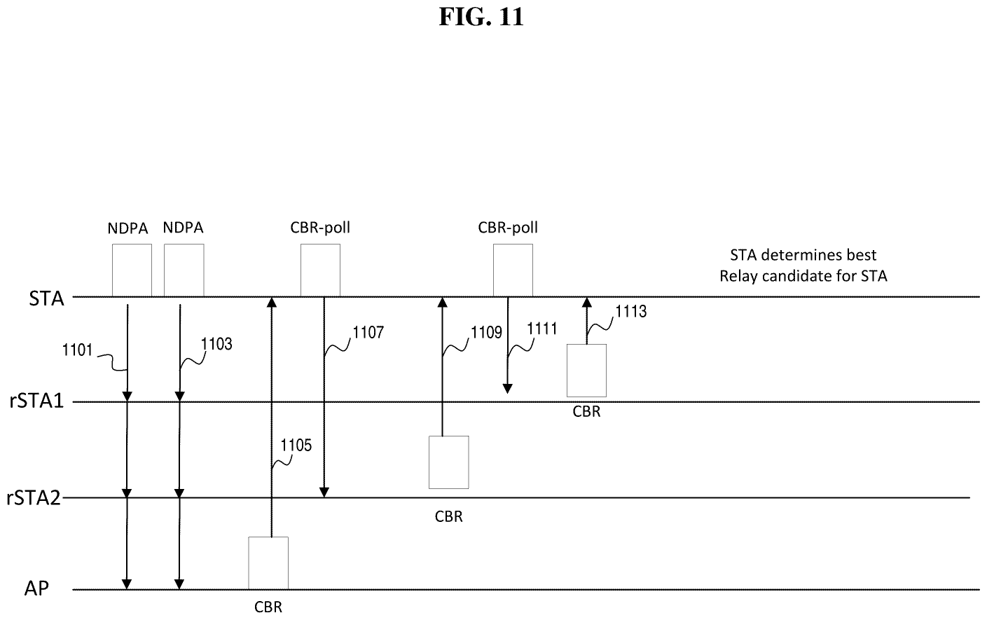

FIG. 11 illustrates an example of determining a relay STA in accordance with an embodiment. In particular, FIG. 11 illustrates communication among an STA, several available relay STAs, including rSTA1 and rSTA2, and an AP. Initially, the STA may assess whether the STA needs relay assistance from one or more relay STAs. The determination may be based on a channel state and/or signal quality that the STA is experiencing with the AP (e.g., high frame retransmission rate, low signal strength, among various other factors). If the STA determines that the STA may need assistance from a relay STA, then the STA may request assistance from one or more relay STAs. As illustrated in FIG. 11, in operation 1101, the STA transmits a first NDPA message to rSTA1, rSTA2, and the AP. Again, in operation 1103, the STA transmits another NDPA message to rSTA1, rSTA2, and the AP. In some embodiments, the relay STAs and/or AP may response with a compressed beamforming report (CBR) message. In particular, in operation 1105, the AP transmits a CBR message to the STA. In some embodiments, a first STA or AP in the NDPA message may send a CBR message without receiving a CBR poll. However, the remaining STAs and/or APs may be polled. Accordingly, as illustrated in FIG. 11, in operation 1105, STA receives the CBR from the AP (without transmitting a CBR poll to the STA). In operation 1107, the STA transmits a CBR-poll message to rSTA2 and in operation 1109, rSTA2 transmits to the STA a CBR message. Likewise, in operation 1111, the STA transmits to rSTA1 a CBR-poll message and in operation 1113 rSTA1 transmits a CBR message in response. Using the received CBR messages from the AP, relay STA2, and relay STA1 respectively, the STA may select an optimal relay STA to perform relay operations for the STA.

In some embodiments, a first device (STA or AP) in an NDPA message may transmit a CBR message without receiving a CBR poll message from the STA. In some embodiments, a remaining set of relay STAs and/or APs may be polled using a CBR poll message transmitted by the STA. In some embodiments, a relay response message may include information regarding a backhaul channel quality, such as an estimated data rate, signal strength, or another channel quality metric. In some embodiments, a relay STA may maintain various channel quality statistics, which may be used by the relay STA for the relay STA's own non-relay related communication with AP and the relay STA may provide one or more of the channel quality statistics to the STA requesting relay assistance.

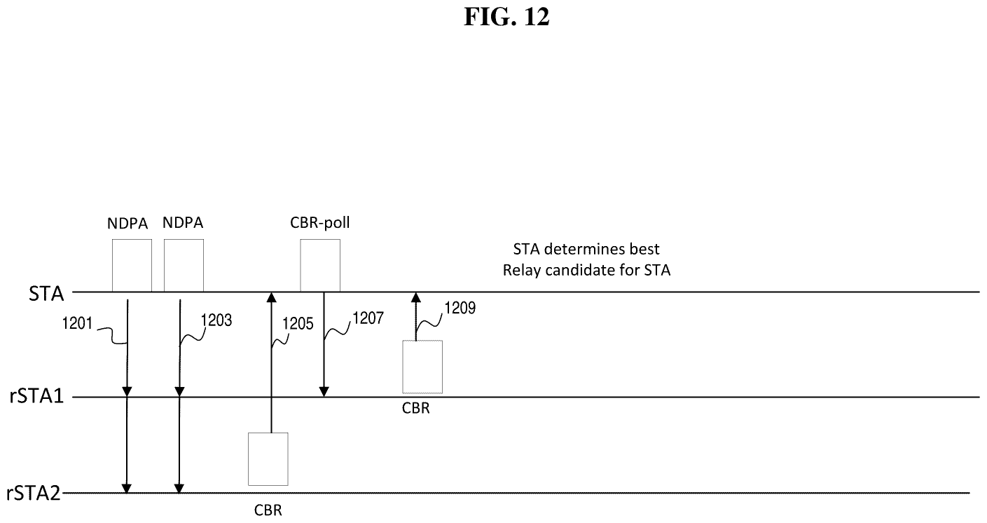

FIG. 12 illustrates an example of determining a relay STA in accordance with an embodiment. In particular, FIG. 12 illustrates communication among an STA and several available relay STAs, including rSTA1 and rSTA2. Initially, the STA may assess whether the STA needs relay assistance from one or more relay STAs. The determination may be based on a channel state and/or signal quality that the STA is experiencing with the AP (e.g., high frame retransmission rate, low signal strength, among various other factors). If the STA determines that the STA may need assistance from a relay STA, then the STA may request assistance from one or more relay STAs. As illustrated in FIG. 12, in operation 1201, the STA transmits a first NDPA message to rSTA1 and rSTA2. Again, in operation 1203, the STA transmits another NDPA message to rSTA1 and rSTA2. In some embodiments, the relay STAs and/or AP may response with a compressed beamforming report (CBR) message. In some embodiments, a first relay STA or AP in the NDPA message may send a CBR message without receiving a CBR poll. However, the remaining relay STAs and/or APs may be polled. Accordingly, as illustrated in FIG. 12, in operation 1205, STA receives the CBR from rSTA2 (without transmitting a CBR poll to rSTA2). After receiving CBR, in operation 1207 the STA transmits a CBR-poll message to rSTA1 and in operation 1209, rSTA1 transmits to the STA a CBR message. Using the received CBR messages from the relay STA1 and relay STA2, respectively, the STA may select an optimal relay STA to perform relay operations for the STA.

In some embodiments, the AP may transmit an announcement message. The announcement message includes one or more of the information items provided in Table 8.

Table 8 provides one or more information items that can be present in the announcement message in accordance with an embodiment.

TABLE 8

| Information | |
|---|---|
| items | Description |
| Relay identifier | One or more information items that can indicate the identifiers of the |
| | relay STAs that the AP considers as potential relay STA for the STA. |
| | e.g., relay STA MAC address, AID, among others. |
| STA identifier | One or more information items that can indicate the STA(s) that the AP |
| | can use the relay STA for. e.g., STA MAC address, AID, among others. |

In some embodiments, the announcement message may be used to change a power state (e.g., sleep state vs. awake state) or capability mode (e.g. lower to higher capability mode).

In some embodiments, upon receiving an announcement message and optionally one or more measurement messages following the announcement message, the relay STA may process the announcement message and transmit a relay response message. In some embodiments, a relay response message may include one or more of the information items as indicated in Table 9.

Table 9 provides information items that may be included in a relay response message in accordance with an embodiment.

TABLE 9

| Information | |
|---|---|
| items | Description |
| Signal strength | One or more information items that may include parameters that may |
| measurement | provide the AP with a signal strength measurement between the AP and |
| | a relay STA. e.g., downlink signal to noise ratio (SNR), received signal |
| | strength indicator (RSSI), among other measurements. |
| Channel state | One or more information items that may include parameters that |
| information | provide the AP with information related to a channel state information. |

In some embodiments, upon receiving an announcement message, an STA may transmit a response message to the AP. A response message may include one or more of the information items similar to those indicated in Table 9 (e.g., similar parameters measured from the STA side).

In some embodiments, when an AP receives a response message from a relay STA and/or an STA, the AP can determine and select an optimal relay STA for an STA. In some embodiments, the AP may poll a relay STA and/or one or more STAs in order to receive response messages from the relay STAs and STAs.

In some embodiments, an announcement message may indicate an order in which the messages may be transmitted. For example, an announcement message may indicate that an STA may transmit a message first, a first relay may transmit a message second, a second relay may transmit a message third, and so forth. In some embodiments, providing an order may allow the various relay STAs to have time to switch from different operating modes and/or state (e.g., low capability to high capability mode, or wake up from a sleep state, among various others).

An example of the above procedure can be as shown in the below figure.

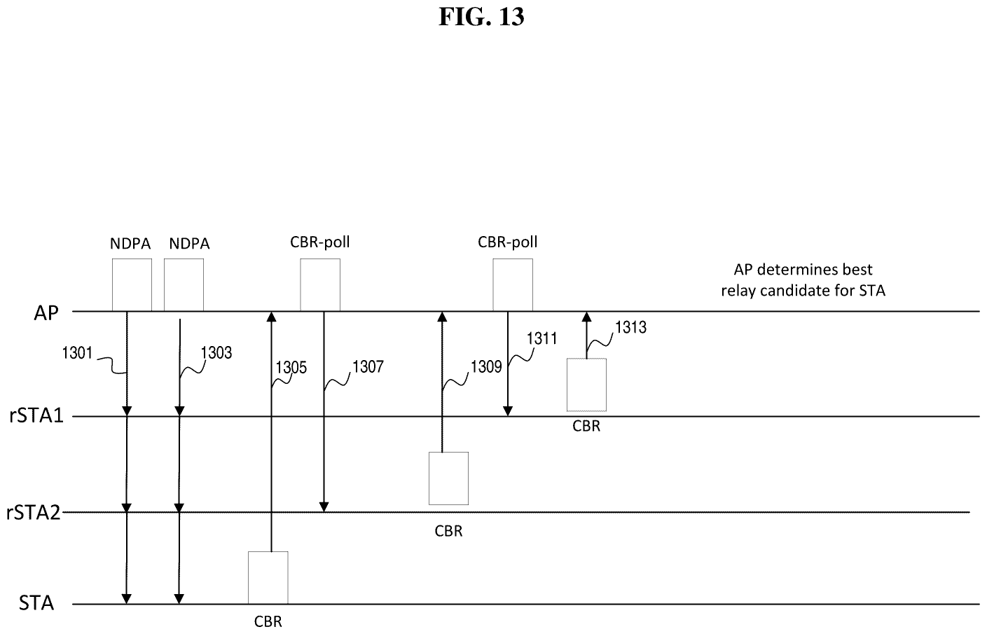

FIG. 13 illustrates an example of an AP determining a relay STA in accordance with an embodiment. In particular, FIG. 13 illustrates communication among an AP, several available relay STAs, including rSTA1 and rSTA2, and an STA. Initially, the AP may assess whether an STA needs relay assistance from one or more relay STAs. The determination may be based on a channel state and/or signal quality that the STA is experiencing with the AP (e.g., poor signal strength, high downlink transmission failure rate, high uplink transmission fail rate, among various others). If the AP determines that an STA may need assistance from a relay STA, then the AP may request assistance from the one or more relay STAs. In some embodiments, the AP may transmit an NDPA frame that identifies one or more relay STA and one or more STAs that the AP expects a response from. As illustrated in FIG. 13, in operation 1301, the AP transmits a first NDPA message to rSTA1, rSTA2, and the STA. Again, in operation 1303, the AP transmits another NDPA message to rSTA1, rSTA2, and the STA. In some embodiments, the relay STAs and/or STA may respond with a compressed beamforming report (CBR) message. In particular, in operation 1305, the STA transmits a CBR message to the AP. In some embodiments, a first device (STA or AP) in the NDPA message may send a CBR message without receiving a CBR poll. However, the remaining STAs and/or APs may be polled. Accordingly, as illustrated in FIG. 13, in operation 1305, AP receives the CBR from the STA (without transmitting a CBR poll to the STA). In operation 1307, the STA transmits a CBR-poll message to rSTA2 and in operation 1309 rSTA2 transmits to the AP a CBR message. Likewise, in operation 1311, the AP transmits to rSTA1 a CBR-poll message and in response, in operation 1313, rSTA1 transmits to the AP a CBR message. Using the received CBR messages from the STA, relay STA2, and relay STA1 respectively, the AP may select an optimal relay STA to perform relay operations for the AP.

Several embodiments in accordance with this disclosure provide improved wireless connectivity for a user device to an AP such a user device may maintain connectivity to the AP outside of a working range of the AP. In particular, a user device or station (STA) may communicate with the AP via one or more relay stations, where a relay station may relay communications, both on the uplink and/or downlink, between the AP and the user device, providing improved wireless connectivity and increased range of communication with the AP.

Several embodiments provide message that may be utilized to determine an optimal relay station from one or more available relay stations based on various channel quality statistics and/or measurements.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the inventive subject matter. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A station (STA) in a wireless network, the STA comprising:
a memory; and
a processor coupled to the memory, the processor configured to:
transmit, to an access point (AP) associated with the STA, a first frame including an identifier of a relay STA and requesting that the AP communicate with the STA via the relay STA;
receive, from the AP, a second frame that confirms the request in the first frame; and
communicate one or more frames with the AP via the relay STA in response to the second frame.

2. The STA of claim 1, wherein:
the first frame includes timing information indicating when STA is to initiate communication with the AP via the relay STA; and
the processor is further configured to initiate the communication with the AP via the relay STA based on the timing information.

3. The STA of claim 1, wherein the STA remains associated with the AP while communicating with the AP via the relay STA.

4. The STA of claim 1, wherein the processor is further configured to:
transmit, to the AP, a third frame that indicates a teardown of the communication with the AP via the relay STA; and
initiate communication directly with the AP after transmitting the third frame.

5. The STA of claim 1, wherein the processor is configured to:
transmit, to one or more other STAs, a third frame indicating that the one or more other STAs are candidates for the relay STA;
receive, from each of the one or more other STAs, a respective frame including signal strength information indicative of communication quality between the STA and a respective other STA; and
select the relay STA among the one or more other STAs based on the signal strength information.

6. The STA of claim 1, wherein the processor is configured to:
transmit, to the AP, a third frame indicating one or more other STAs that are candidates for the relay STA;
receive, from the AP, a fourth frame that includes signal strength information indicative of communication quality between the AP and a respective STA in the one or more other STAs; and
select the relay STA among the one or more other STAs based on the signal strength information.

7. The STA of claim 1, wherein the processor is configured to:
receive, from the AP, a third frame that requests signal strength information of a signal between the AP and the STA; and
transmit, to the AP, a fourth frame that includes the signal strength information of the signal between the AP and the STA.

8. An access point (AP) in a wireless network, the AP comprising:
a memory; and
a processor coupled to the memory, the processor configured to:
receive, from a station (STA) associated with the AP, a first frame including an identifier of a relay STA and requesting that the AP communicate with the STA via the relay STA;
transmit, to the STA, a second frame that confirms the request in the first frame; and
communicate one or more frames with the STA via the relay STA in response to the second frame.

9. The AP of claim 8, wherein the processor is further configured to:
transmit, to the relay STA, a third frame requesting confirmation that the relay STA will perform relay operations for the STA; and
receive, from the relay STA, a fourth frame in response to the third frame that confirms that the relay STA will perform the relay operations for the STA.

10. The AP of claim 8, wherein:
the first frame includes timing information indicating when the STA is to initiate communication with the AP via the relay STA; and
the processor is configured to initiate the communication with the STA via the relay STA based on the timing information.

11. The AP of claim 8, wherein the AP remains associated with the STA while communicating with the STA via the relay STA.

12. The AP of claim 8, wherein the processor is further configured to:
receive, from the STA, a third frame that indicates a teardown of the communication with the AP via the relay STA; and
initiate communication directly with the STA after receiving the third frame.

13. The AP of claim 8, wherein the processor is further configured to:
receive, from the STA, a third frame indicating one or more other STAs that are candidates for the relay STA; and
transmit, to the STA, a fourth frame that includes signal strength information indicative of communication quality between the AP and a respective STA in the one or more other STAs.

14. The AP of claim 8, wherein the processor is further configured to:
transmit, to the STA, a third frame that requests signal strength information of a signal between the AP and the STA; and
receive, from the STA, a fourth frame that includes the signal strength information of the signal between the AP and the STA.

15. A relay station (STA) in a wireless network, the relay STA comprising:
a memory; and
a processor coupled to the memory, the processor configured to:
receive, from an access point (AP), a first frame requesting confirmation that the relay STA will perform relay operations for a STA;
transmit, to the AP, a second frame in response to the first frame that confirms that the relay STA will perform the relay operations for the STA;
receive, from the AP, a third frame intended for STA and forward the third frame to the STA; and
receive, from the STA, a fourth frame intended for the AP and forward the fourth frame to the AP.

16. The relay STA of claim 15, wherein the processor is further configured to:
receive, from the STA, a fifth frame that includes an identifier of the relay STA that the STA is considering for performing relay operations for the STA; and
transmit, to the STA, a sixth frame that includes signal strength information indicative of communication quality between the relay STA and the STA.

17. The relay STA of claim 15, wherein the processor is further configured to:
receive, from the AP, a fifth frame that includes an identifier of the relay STA that the AP is considering for performing relay operations for the STA; and
transmit, to the AP, a sixth frame that includes signal strength information indicative of communication quality between the relay STA and the AP.

18. The relay STA of claim 16, wherein the fifth frame is a null data packet announcement frame and the sixth frame is a compressed beamforming report.

19. The relay STA of claim 15, wherein the processor is further configured to:
transmit, to the AP on behalf of the STA, a fifth frame that requests that the AP communicate with the STA via the relay STA.

20. The relay STA of claim 15, wherein the processor is further configured to:
transmit, to the AP on behalf of the STA, a fifth frame that indicates a teardown of the communication via the relay STA.
